(19) United States
(12) Patent Application Publication
(10) Pub. No.: US 2011/0228936 A1
(43) Pub. Date: Sep. 22, 2011

(54) WIRELESS SYNCHRONIZATION OF REMOTE SWITCHES FOR END DEVICE APPLICATIONS

(75) Inventor: Emanuel H. Silvermint, Shoreview, MN (US)

(73) Assignee: ATEK Products Group, Brainerd, MN (US)

(21) Appl. No.: 13/069,013

(22) Filed: Mar. 22, 2011

Related U.S. Application Data
(60) Provisional application No. 61/316,250, filed on Mar. 22, 2010.

(51) Int. Cl. G06F 13/42; H04K 1/00; H04L 7/00

(52) U.S. Cl. 380/255; 340/4.2

(57) ABSTRACT

An apparatus comprises a first device including a first switch and a transmission circuit. The switch circuit is in one of a plurality of possible switch states. The transmission circuit is communicatively coupled to the first switch circuit and is configured to transmit a wireless communication signal upon the first switch changing state. A second device includes a receiver circuit and a second switch circuit. The receiver circuit is configured to remotely receive the wireless communication signal from the transmission circuit. The second switch circuit is communicatively coupled to the receiver circuit, wherein, upon receipt of the wireless communication signal, a state of the second switch is synchronized to the state of the first switch.

### CLAIM OF PRIORITY

This application claims the benefit of priority under 35 U.S.C. §119(e) of, U.S. Provisional Patent Application Ser. No. 61/316,250, entitled “WIRELESS SYNCHRONIZATION OF REMOTE SWITCHES FOR END DEVICE APPLICATIONS,” filed on Mar. 22, 2010, the benefit of priority of which is claimed hereby, and of which is incorporated by reference herein in its entirety.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of portions of an example of a detection device to detect one or more sensed events.

FIG. 2 is a block diagram of an example of a receiving device to receive a wireless communication signal from a detection device.

FIG. 3 is a block diagram of an example of portions of a system that includes a detection device and a receiving device and an end device.

FIG. 4 shows a block diagram of portions of another example of a detection device

FIG. 5 shows a block diagram of portions of another example of a receiving device.

FIG. 6A is flow diagram of an example of a process of installing software or firmware in one or both of the detection device and the receiving device.

FIG. 6B is a flow diagram of an example of a process to update software or firmware in one or both of the detection device and the receiving device using wireless communication.

FIG. 7 is an illustration of one or more wireless presence-sensing mats installed on a stairway.

FIGS. 8A and 8B illustrate portions of examples of combining face recognition technology with synchronized wireless switch technology.

FIG. 9 shows an example of wireless mats to direct access of persons passing through an area.

### DETAILED DESCRIPTION

This document relates generally to electronic switches. More specifically, this document is related to synchronizing the state of electronic switches that are remotely located from each other.

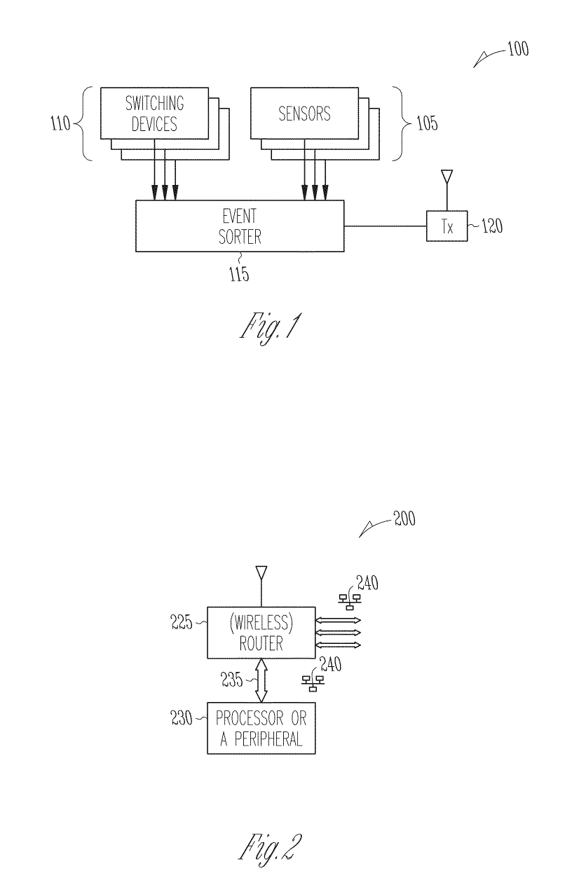

FIG. 1 is a block diagram of portions of an example of a detection device 100 to detect one or more sensed events. The detection device 100 includes one or more sensors 105. In some examples, the sensors 105 provide an electrical sensor signal based on proximity of an object to the sensor. More generally, the sensors 105 may be any sensor that can sense a change in its environment. The detection device 100 also includes one or more switch circuits 110. In some examples, the switch circuits 110 are communicatively coupled to the sensors 105. The communicative coupling allows electrical signals to be communicated between the sensors 105 and the switch circuits 110 even though there may be intervening circuitry between the sensors 105 and the switch circuits 110. A switch circuit may have one or more possible states (e.g., logic states). A switch circuit is configured to be one of the possible states based on a sensor signal received from a sensor.

The detection device 100 also includes an event sorter 115. The event sorter 115 receives one or more of the states of the switch circuits and the sensor signals and transmits a wireless communication signal using transmitter 120 according to one or both of the received states and received sensor signals.

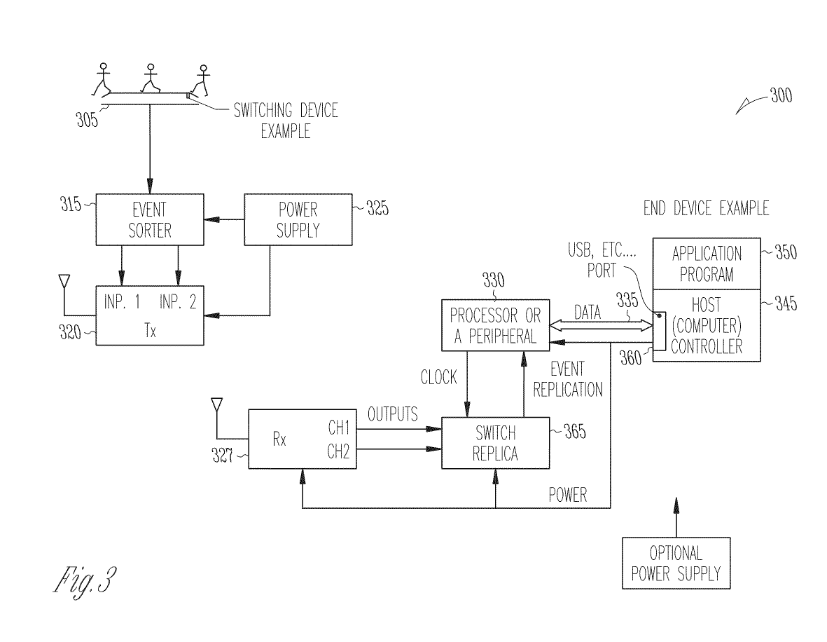

FIG. 2 is a block diagram of an example of a receiving device 200 to receive a wireless communication signal from the detection device 100. The receiving device 200 includes a wireless receiver 225 (e.g., a wireless router, or wireless transceiver circuit) and a processor 230. The processor 230 can include a microprocessor, an application specific integrated circuit (ASIC), controller, or any peripheral device to manage remote communication with the detection device. In some examples, the wireless receiver 225 is communicatively coupled to the processor 230 using a data bus 235. In some examples, one or both of the wireless receiver 225 and the processor 230 are communicatively coupled to one or more communication networks 240. The communications networks 240 may include a computer network (e.g., a local area network (LAN) or the Internet) or a telephone network (e.g., a wireless cell phone network).

The receiving device 200 is communicatively coupled to an end device (not shown), such as by a network or a data bus. In certain examples, the end device includes a host device (e.g., a computer) performing a function. The end device may change its operation based on a communication signal received from the detection device 100 via the receiving device 200. A non-exhaustive list of examples of the end device 200 includes an industrial safety and control system, a security system, a kiosk, an automated teller machine (ATM), a remote control system (e.g., a door controller or other enabling/actuating device), and an upgradeable access system (e.g., unsecured access is upgradeable to secured). In some examples, the detection device 100 of FIG. 1 includes a proximity or presence sensor. Based on a signal from a sensor 105 in FIG. 1, the end device may perform a function such as granting access to an area (e.g., by opening a door or allowing a door to be opened), changing operation of (e.g., starting or stopping) an industrial machine, playing an advertisement, allowing operation of a user interface, or providing an alert or alarm based on the sensor signal.

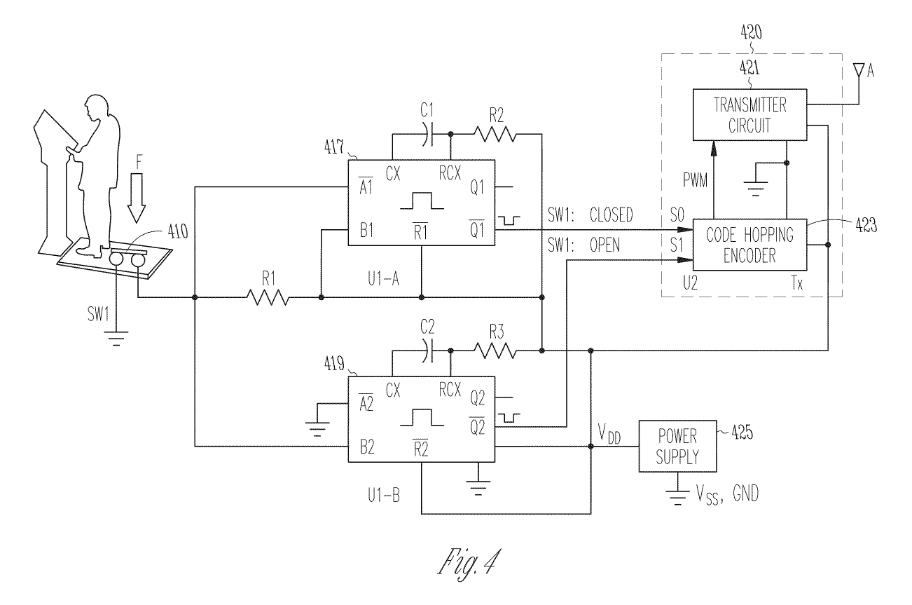

FIG. 3 is a block diagram of an example of portions of a system 300 that includes a detection device and a receiving device and an end device. The detection device includes an event sorter 315, a wireless transmitter 320, and a power supply 325. The detection device also includes a sensor 305. In an illustrative example, a sensor 305 is included in a presence-sensing floor mat.

Presence-sensing mats are useful, for instance, to trigger automatic doors to open or close when stepped upon. Such devices can be found at doors to buildings, such as stores, airports, and hotels, for instance. Presence-sensing mats are also useful in other situations, such as industrial safety applications in which mats can sense whether a person or object is within a safe zone or, alternatively, an unsafe zone during operation of a machine. Such mats can be configured to enable the machine if the person or object is within the safe zone or disable the machine so as to not operate while a person or object are within the unsafe zone. Descriptions of presence-sensing mats can be found in Pehrson, “Mat System and Method There for,” U.S. Patent Pub. No. US 2009/0065344, filed Feb. 26, 2008, which is incorporated herein by reference in its entirety.

In some examples, one or more of the sensor 305, a switch circuit (not shown), the event sorter 315, the transmitter 320, and the power supply 325 are included in the presence-sensing mat 305. The power supply 325 may provide power or energy to one or more of the sensor 305, the switch circuit, the event sorter 315, and the transmitter 320.

The receiving device includes a wireless receiver 325 and a processor 330. The end device includes a host device 345 (e.g., a computer or other controller) and an application program 350 to execute on the host device 345. In some examples, receiving device is communicatively coupled to the end device via a data bus 355. In some examples, the data bus 355 can be a serial data bus (e.g., a universal serial bus (USB)) and the host controller includes a USB port 360.

It may be desirable for one or both of the receiving device and the end device to know the state of the switch in the sensing device (i.e., the presence-mat in this example). In some examples, a mere toggle switch may be insufficient. The end device may need to know specifically whether someone is standing on the mat or has left the mat; rather than only that one or the other has occurred. An example of toggle function is a TV-remote power on/off button. To turn the TV on or off the on/off button is depressed. It does not matter whether the button is immediately released or stays depressed. Either way, the TV stays in the same state. The TV does not know that the button is stays depressed or is released after the initial button press.

Another example is a remote car door lock/unlock fob. The fob may include one button to toggle the state of door lock between locked and unlocked, or the fob includes a first button to lock the car doors and a second button to unlock the car doors. Pressing the lock button locks the doors. It doesn't matter whether the lock button is immediately released or stays depressed; the door locks or remains locked. The car door has two states. Either one command is sent to toggle the lock of door or separate commands are sent to lock the doors and to unlock the doors.

In the example of FIG. 3, the receiving device includes a switch replica circuit 365. The switch replica circuit 365 replicates the state of the switch in the sensing device. Stated another way, the switch replica circuit 365 is synchronized to the state of the switch in the sensing device. This allows the receiving device and end device to know the state of the switch in the sensing device. In some examples, the state of the switch in the sensing device is a single pole, single throw switch (SPST), and the switch replica circuit replicates a SPST-type switch.

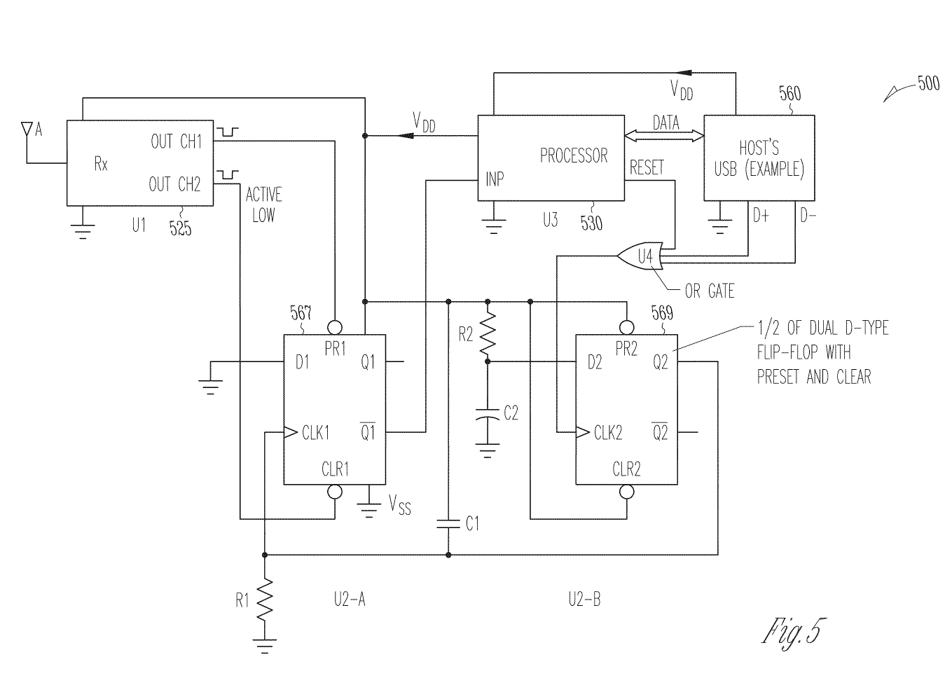

FIG. 4 shows a block diagram of portions of another example of a detection device 400. The detection device includes a switch 410, a transmitter 420, and a power supply 425. The detection device 400 also includes event sorter shown in greater detail which includes a first one-shot 417 (monostable vibrator circuit, labeled U1-A) and a second one shot 419 (U1-B). In the example shown, the sensing device is a presence-sensing mat that includes a switch 410. The presence-sensing mat may include one or more of the switch 410, the transmitter 420, the power supply 425, and the event sorter. For instance, a compartment cavity may be formed in the mat that is covered by a door on the side opposite to the face of the mat. The cavity may hold one or more of the circuits of the detection device 400. The power supply may include a button size battery.

In some examples, the switch 410 includes a manually operated electromechanical device having at least a single set of electrical contacts. Each set of contacts can be in one of two states: either ‘closed’ meaning the contacts are touching or ‘open’, meaning the contacts are separated in order to prevent current flow. Switches and relays are classified by the number of poles and throws. The pole is the terminal common to every path. Each position that the pole can connect to is called a throw. Many switches are solid-state devices and a great variety of applications use relays, both switches and relays may be operated automatically to provide power or control signal to a system. There is often a requirement to operate these devices remotely. A special case is a battery-operated wireless control of a switch or a relay.

According to some examples, the switch 410 can be a SPST switch. Force on the mat due to a person or object on the mat may place the switch 410 in a first state (e.g., closed or active) and the switch may be placed in a second state (e.g., open or inactive) when there is not a load on the mat. For instance, the switch may include two plate contacts within the mat that become electrically connected (e.g., closed) as the upper plate moves downward toward the lower plate. When a person steps off of the mat, the upper plate moves upward and the plate contacts are electrically disconnected (e.g., open).

The event sorter is designed to convert an action of an original switch or a relay into a RF-transmittable code that carries information of its state. One-shot U-1A has reset and power-on reset functionality. One-shot U1-A provides a negative-going pulse on the complement output [symbol] Q1 when the gravity force F is applied to the mat and the switch 410 is activated. In certain examples, one-shot circuits may be used that provide a negative-going pulse on the Q1 output. The duration of the output pulse is determined by the values of capacitor C1 and resistor R2. In certain examples, the values of C1 and R2 are chosen to provide a pulse width above 10 milliseconds (iris) to provide de-bouncing protection for operation of the switch.

When the switch 410 is open, its upper contact plate and input [symbol] A1 of one-shot U1-A is at V_{DD} potential through the resistor R1. When the switch 410 becomes closed due to the force, the same points are grounded through the lower plate of the switch. As the B1 input and reset input [symbol] R1 of the one-shot are always at a high logic level (e.g., V_{DD}), the switch closing changes the [symbol] A1 input from logical high to low, hence issuing the negative pulse from the [symbol] Q1 output.

When the person steps off the mat, the high level at the input [symbol] A1 is restored, which does not affect the U1-A circuit because of the one-shot functionality. Table 1 is a Truth Table to show functionality of the U1-A one-shot circuit. Because the R1 input is connected to a high level, the first line and the last line of Truth Table are not used and are irrelevant. The third and fourth lines of the Truth Table are not used because the B1 input is connected to a high level. Because the Q1 output is not used in the example, the fourth column is irrelevant.

Note that in the Truth Table,

| | |
|---|---|
| H | high level |
| L | low level |
| ↑ | rising edge of a signal |
| [symbol] | is the negation symbol (NOT) |
| Q0 | is the level of Q before the indicated input conditions were |
| | established |
| * | unstable configuration; it will not persist when preset and |
| | clear inputs return to their inactive (HIGH) level. |
| [symbol] | irrelevant situation for this circuit due to indicated |
| | input condition or unused output |
| [symbol] | permitted order of events |
| [symbol] | negative going pulse |
| [symbol] | positive going pulse. |

One-shot circuit U1-B is activated when the person steps off the mat. As with U1-A, the reset input [symbol] R2 of U1-B may be connected to a logic high (e.g., V_{DD}) to inactivate the reset function. However, the [symbol] A2 input is always logic zero (e.g., connected to circuit ground or GND). In some examples, the transmitter 420 includes a processor (not shown) and the input [symbol] R2 is connected to an output of the processor. This allows for a level of control for recovery and synchronization in the event of component failures.

When the person is on the mat, input B2 is at a logic low (e.g., GND) or zero, and a high level or one is present at the [symbol] Q2 output. When the person steps off the mat, B2 assumes V_{DD} potential through the resistor R1, and the [symbol] Q2 output signals with the negative-going pulse that switch 410 is open. In the example of the Figure, the value of the capacitor C2 and resistor R3 are identical to the values of capacitor C1 and resistor R2 correspondingly to provide the same output pulse width. In another embodiment, these values are different to alter the pulse widths and hence enable pulse width modulated (PWM) coding.

Table 2 is a Truth Table showing the functionality of the U1-B circuit.

In the example of FIG. 4, one shot U1-A generates a negative going pulse when switch 410 is closed, and one shot U1-B generates a negative going pulse when switch 410 is open. These pulses are received by the S0 and S1 inputs respectively of the transmitter circuit 420. The transmitter 420 includes a transmitter circuit 421 to wirelessly communicate information about the state of the switch 410.

In some examples, the transmitter 420 includes a code hopping encoder 423. The code hopping encoder 423 performs an encryption algorithm to provide a unique (e.g., rolling) code for the state of switch 410. In certain examples, the code hopping encoder 423 performs the KEELOQ® Encryption Algorithm.

The encryption is useful in security applications. When the state of switch 410 changes, a different encrypted code is sent by the transmitter circuit 421. A code decoder circuit is included in the receiving end of the system. The switch information is encoded using a secret “key” and the received code is de-encrypted using a secret decoding key. This prevents interception and/or transmission of false switch state information to defeat a security system. Because, the decoding key is not transmitted, the decoding method cannot be determined by signal interception.

Note that according to this invention, there is no activity in the circuit while the switch 410 is in either closed or open state. The switch state does not need to be continuously reported as a system according to these several examples provides synchronous operation. The transmitter 420 can enter a sleep mode until it receives its next signal from the one shot circuits. If the logic circuits are implemented with CMOS transistors or gates, these circuits do not consume much energy because these logic circuits draw current only during state transition to drive parasitic capacitors. Because the circuits are mostly dormant until a switch event takes place, the method of transmitting the state described herein provides for battery energy savings of that is, very conservatively, at least three to four orders of magnitude over a system that determines a switch state through recurrent sampling of the switch.

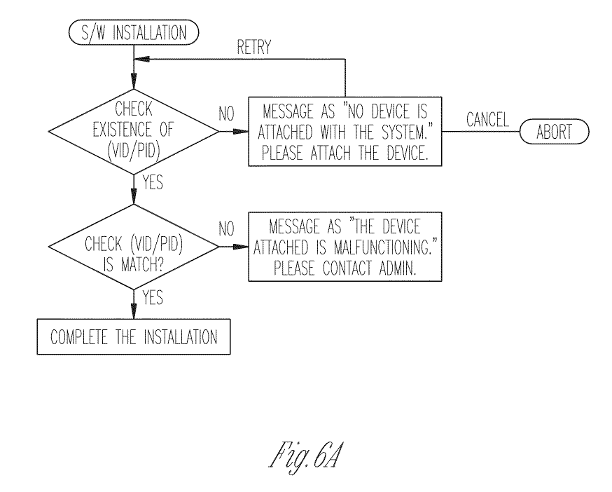

FIG. 5 shows a block diagram of portions of another example of a receiving device 500. In some examples, the receiving device 500 is included in a kiosk stand. The receiving device 500 includes a wireless receiver 525 and a processor 530. The diagram also shows an example connection to a USB port 560 of an end device. In the Figure, an example of a switch replica circuit referred to in FIG. 3 is shown in more detail. The switch replica circuit includes a first D-type flip flop 567 (bistable vibrator circuit, labeled U2-A) and a second D-type flip-flop circuit 569 (labeled U2-B).

The U2-B flip-flop is used to provide a controlled reset to the U2-A flip-flop upon a reset event such as power-up, a cable reconnect, a power supply glitch, or a reset event generated by the host device. A truth for the U2-B flip-flop is shown in Table 3 below.

In the example, the PR1 and CLR1 inputs are connected to V_{DD} (circuit voltage or power), so table entries where either PR1 and/or CLR1 are low are irrelevant. The inverted Q2 output is not connected, so that column of the Truth Table is irrelevant. In the last row of the Truth Table, when the CLK2 input stays low, the output of the flip-flop is in its previous state Q0.

When a reset event occurs, a transition to the clock (CLK2) input is provided by OR-gate U4. An RC delay circuit (R2 and C2) is connected to the data input (D2) of the flip-flop. The initial charging of the capacitor C2 through resistor R2 delays the rising of V_{DD} at D2 to allow the PR2 and CLR2 inputs to reach the high state before the CLK2 as well as allowing the output Q2 to switch from low to high.

The switch of the Q2 output from low to high serves as a reset U2-A at the CLK1 input after which the circuit is ready to process signals from the receiver Rx. Due to the effect of the R2-C2 timing at the D2 input of U2-B, by the time U2-A becomes reset, the processor 430 and any microcontroller of the wireless receiver 425 are also finished being reset. Table 4 shows a Truth Table for the U2-A flip-flop.

Because the data input of the flip-flop D1 is connected to ground, fourth line of the Truth Table is irrelevant. Because the Q1 output is not connected, that column of the Truth Table is irrelevant. The third line of the Truth Table corresponds to the unstable state of the flip-flop. This state is not used due to the fact that, in this example, the PL1 and CLR1 inputs are used to emulate the opposite states of a SPST-type switch. Consequently, the third line of the Truth Table irrelevant.

The fifth row of the Truth Table corresponds to a reset condition. The transition on the Q2 output provides the clock to clock in the low connected to D1.

For the last row of the Truth Table, the initial charging of capacitor C1 through resistor R1 sets the clock (CLK1) input low and prepares this input of the U2-A flip-flop for reset. The RC time constant of R1-C1 is designed to be shorter than RC time constant of R2-C2, to ensure that the rising edge of the signal from Q2 of U2-B is arriving after the CLK1 input of the U2-A is set low. Thus the design insures that the initial signal level at [symbol] Q2 of U2-A upon the reset is correct (high.) This level would be present at the hip connector of the processor 430. The last row of the Truth Table represents the disconnected state of the original SPST switch in the sensing device.

In the example of FIG. 5, the processor 530 can be connected to a USB port 560 of the end device or host. The USB 560 allows control by the end device for restarting the system.

The USB transmits binary signals that are represented by one of the “non return to zero inverted” (NRZI) conventions. The signals can be carried over two wires, Data+ and Data−. A two-level signal has a transition that occurs on the leading edge of the clock if logical zero is sent, while logical one has no transition. A USB may insert an additional zero bit after six consecutive logical one bits (e.g., bit stuffing) to aid clock recovery. This makes a seventh consecutive one in a transmitted word an error. In some USB implementations, the seventh bit is simply ignored.

In some examples, there can be 15 kilo-Ohm (kΩ) pull-down resistors on each data line of the host. When no device is connected to the USB port 560, the lines are in “single-ended zero” state (SE0), and it indicates a reset or disconnected connection. A USB device pulls up a data line through a 1.5 kΩresistor, which changes a line state to the idle state (e.g., “J” state). If a zero bit is transmitted, the voltage changes to the opposite (e.g., “K” state.) In case of a problem with data wire connectivity between the processor 530 (U3 in FIG. 5) and the end device, the following restart convention may be used in an attempt to re-establish synchronization.

In some examples, a disconnection is evident by a persistent change from J to SE0 state. This results in one or more of the following measures:
Allowing application software of the end device to handle the disruption in a desired way, for example, by explaining the connectivity loss in a displayed message, or by halting a controlled process, or otherwise handle the situation by the end device practiced in accordance with the present invention;
Toggle V_{DD} off and back on at the processor U3; V_{DD} then goes to the Receiver U1 and D flip-flops U2, and this will drive all necessary resets to the initial circuit conditions;
Use Data+ or Data− line change from SE0 to J-state as a reset through U4 or gate;
Repeating the above measures as appropriate to the end application at the end device.

In some example, the transmitting circuitry is also reset (not shown in the drawings) in addition to the above measures. This is achieved by employing transceivers in the system instead of receiver U2 and transmitter 420 in FIG. 4. Further, the transmitter 420 may hold a record of the last signal sent and a command carried by that signal can be repeated by retransmission to insure a correct phase of synchronization.

Yet in another embodiment, additional reliability is achieved by redundancy of reset means. As depicted in the FIG. 5, a regular or upon-fault reset could be provided by either the processor U3 or the USB 560 of the host device through OR-gate U4. As depicted, V_{DD} could be optionally provided from a power source or the USB 560. It is not necessary bra power source (not shown) for the Or-gate U4 to come from the processor U3, and the power source could be drawn from either processor U3, host device, or other supply source. However, processor U3 can be controlling the power to receiver U1 and D flip-flops U2. Hence, power can be temporarily withdrawn from D flip-flops U2 to discharge the capacitors as needed for the robust reset conditions set in the descriptions provided herein.

For instance, if for some reason the reset function of processor U3 fails due to a component failure or printed circuit board (PCB) failure, another processor function (power control) could still prevail. In this case, the reset would come from the USE through Or-gate U4. This reset would be provided after the occurrence of the initial idle state J. That is, up on the plug connection, the USB bus is reset using a prolonged (10 to 20 milliseconds) SE0 signal, which provides necessary initial low on both data lines, as is evident from the truth tables. In such embodiment, there should be a pull up resistor at processor U3 that would be connected to the USB bus; it would indicate a device has been connected to the bus as soon as the plug is inserted. The host device may then attempt to reset processor U3.

Note that during this 10 to 20 milliseconds SE0 interval, processor U3 should issue a positive-going reset pulse for the successful operation of the circuitry described in this example. This pulse will set the output of the Or-gate U4 high, and CLK2 of flip-flop U2-B will set the Q2 output low as the D2 input of flip-flop U2-B is still low after the power up. If it is a “hot swap-like connection,” in one embodiment where processor U3 is powered by the USB bus, processor U3 would time the reset pulse appropriately to the 10-20 milliseconds window. After a sufficient time interval is allowed for initialization of a processor or controller of receiver U1, completion of the remaining part of initialization of the processor U3, and completion of the communication set up between processor U3 and the USB bus, capacitor C2 should get charged to logic high and processor U3 would issue a second pulse ensuring transition of output Q2 of the flip-flop U2-B to high, which sets up flip-flop U2-A to its initial state.

In some examples, the data lines of the USB toggle KJKJKJKK (‘00000001’) as a synchronization sequence at the start of a USE packet. This sequence ensures the necessary transition from lows of SE0 at the two inputs of Or-gate U4 followed by the high levels of the synchronization sequence.

There may be a longer synchronization sequence (“chirping”) for a high bandwidth USE. However, it may not be necessary to know the exact USB details to implement the redundancy of reset conditions and scenarios described. It is to be noted that upon reading this disclosure, one skilled in the art would be able to apply the disclosure to provide solutions for various applications of the examples described herein.

Returning to FIG. 4, in some examples, the detection device 400 includes a mode-change circuit (not shown) that can place the detection device in a special mode. Examples of a mode change circuit include a magnet activated reed switch, a radio frequency identifier (REID) circuit, and a card reader device.

The special mode can be entered to update some function of the detection device 410. In some examples, transceivers are included in the detection device 400 to allow receiving of information by the by the detection from the end device or another device. An example of information to be transmitted to the detection device includes software or firmware to control the detection device 400. In some examples, the special mode circuit is used to place device in a software or firmware update mode. In some examples, the software is updated using wireless communication. A secure update method (e.g., encryption) can be used to prevent corruption of the software or firmware. Wireless updating can also be used to provide a unique secret key to the detection device for encryption of codes transmitted by the detection device.

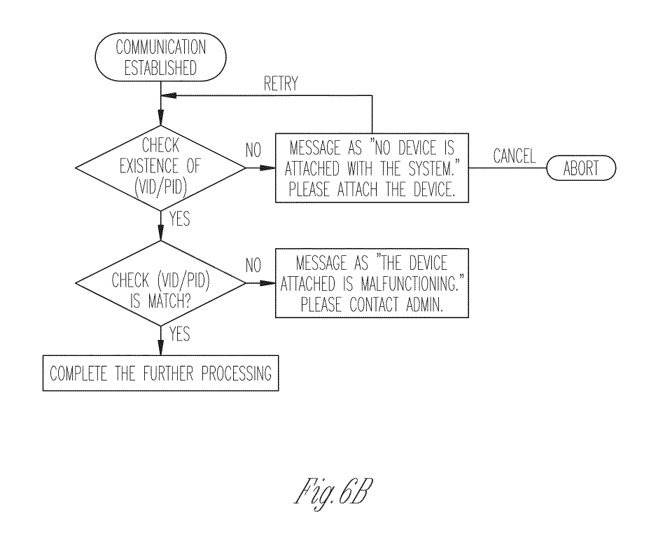

FIG. 6A is flow diagram of an example of installing software or firmware in one or both of the detection device 400 and the receiving device. FIG. 6B is a flow diagram of an example of updating software or firmware in one or both of the detection device 400 and the receiving device using wireless communication.

The devices described herein are easy to install and provide effective solution to enhanced safety in the workplace or public places. These devices can be deliberately designed and manufactured in the easily recognized colors as an application dictates.

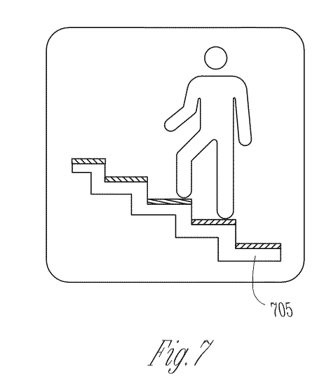

FIG. 7 is an illustration of one or more wireless presence-sensing mats 705 installed on a stairway. Presence-sensing mats with Synchronous Wireless Switch (SWS) technology allow for installation on stairs as intelligent security monitoring and safety monitoring. Stair monitoring can be a challenge for approaches that use a light curtain (e.g., implemented with photoelectric cells). Security monitoring of stairs with a camera is noticeable and can be easily disabled. Additionally, image monitoring often involves an operator, whereas a wireless mat solution can be fully automatic. Hardwired mats may make an implementation impractical. A wireless approach is more easily implemented. Wireless mats with switch synchronization allow for precise prompting and alarm generation for securing an important channel in a multi-channel security system.

Note that the examples describe replicating the states of a SPST switch, i.e., a closed state or an open state of the switch. Other switch types may be used, such as a single pole double throw (spar) switch or a double pole double throw (DPDT) switch. For instance, a SPDT switch is used to connect either a first input line or a second input line to an output. The event sorter can be used to transmit whether the SPDT switch is connected to the first or the second input line. The switches could be also implemented in, but not limited to, a mat(s) form. Other switch types may be used to provide for more sophisticated functions and scenarios and in other applications.

In another example, a detection device may detect the state of multiple switches. For instance, the switches may be dual state switches (e.g., button-type switches). A specified combination of depressed button may have its own meaning or function. For synchronized operation, the detection device may perform a two step process where the detection device waits for a button combination to be entered and then transmits the combination upon a trigger event (e.g., upon depression of a send button or upon a time out condition). In another example, each button corresponds to one function and a state of the button switch is transmitted to enable or disable the function. Both the transmitter and receiving device may use PWM or another method (e.g., encryption) for encoding and decoding the button press information.

The examples described often use a wireless mat to illustrate an application, but it is to be noted that there are many “non-mat” applications and implementations. A non-mat implementation works in a similar way as the described mat applications. The circuit or application of the end device assigns the function that is analogous to the closing of that mat, which may disallow or disable the end device or an application of the end device. In some examples, such as kiosk-like applications, it may be beneficial to have a protective area that must be empty, or may be an area requiring permission to enter. This could be achieved by a combination of switches such as described previously.

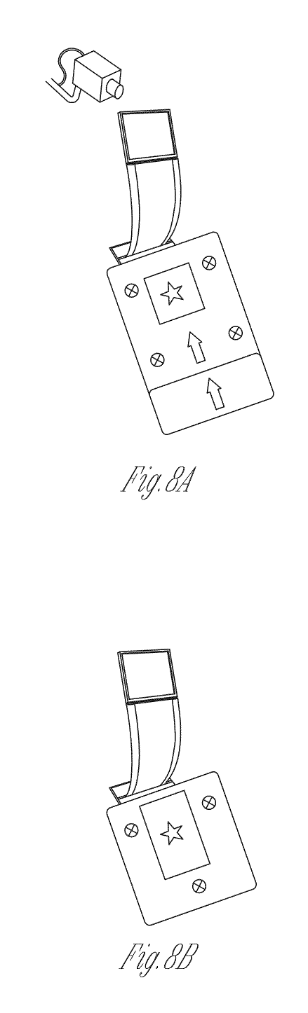

FIGS. 8A and 8B illustrate portions of examples of combining face recognition technology with SWS technology. Camera tracking is often used in face recognition applications to properly position the camera for proper exposure and sensing of the subject. However, camera tracking control can be relatively expensive and this cost barrier prevents deeper market penetration by the face recognition technology. Wireless SWS mats can be used to complement the face recognition technology without the expensive camera tracking technology. Wireless SWS mats allow instructions to be given and/or a proper camera trigger at the proper place and time. Additionally, a display of kiosk-like information can be added to the security camera.

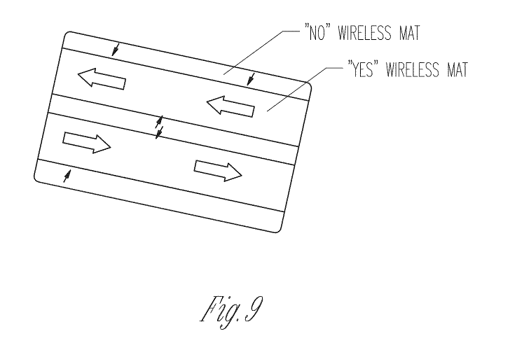

In another example, wireless SWS mats can be used to implement a “side guard.” FIG. 9 shows an example of wireless mats to direct access of persons passing through an area. In the example shown, the elongated side guard can indicate a wrong going direction and direct the traffic through the designated area and/or in designated direction. In some applications, SWS technology can accomplish the same functions as conventionally done with switch-based edge guards, stair-guards, guard gates, bollards, handrails, or access gates.

In some examples, a device with SWS technology may be used in a hazardous area, such as a gas station or a chemical plant. Typically, electronic devices are removed from the hazardous area to be serviced for maintenance. The special mode circuit described previously may be used to minimize the danger of initiating combustion. In some examples, the special mode circuit includes a reed switch that is activated with a magnet. When the magnet is placed near the SWS device and is detected by the reed switch, power is disconnected from at least a portion of the device. In some examples, the SINS device includes a fastener for the magnet to ensure that magnet is placed correctly in proximity to the reed switch. In certain examples, an LED may indicate (e.g., a green LED) may indicate that power is removed from the portion. When the magnet is removed, power is restored to the portion of the SWS device.

### ADDITIONAL NOTES

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. Method examples described herein can be machine or computer-implemented at least in part.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. An apparatus comprising:
a first device including:
a first switch circuit, wherein the switch circuit is in one of a plurality of possible switch states; and
a transmission circuit communicatively coupled to the first switch circuit and configured to transmit a wireless communication signal upon the first switch changing state; and
a second device including:
a receiver circuit, configured to remotely receive the wireless communication signal from the transmission circuit; and
a second switch circuit communicatively coupled to the receiver circuit, wherein, upon receipt of the wireless communication signal, astute of the second switch is synchronized to the state of the first switch.

2. The apparatus of claim 1, wherein the first device includes an event sorter circuit communicatively coupled to the first switch, wherein the event sorter circuit is configured to convert an action of the first switch into a transmittable code that includes information about the state of the first switch.

3. The apparatus of claim 2, wherein the transmission circuit includes a code hopping encoder circuit configured to encrypt the transmittable code.

4. The apparatus if claim 1, wherein the first device enters a sleep mode between transitions of the first switch circuit from a first state of the plurality of states to a second state of the plurality of states.

5. The apparatus of claim 1, including:
a processor communicatively coupled to the second switch circuit,
wherein circuit power for the second switch circuit is provided by the processor, and wherein the processor is configured to reset the second switch circuit.

6. The apparatus of claim 5,
wherein the processor and the second switch circuit are communicatively coupled to a host device bus, and
wherein the host device is configured to reset one or more of the second switch circuit and the processor via the host device bus.

7. The apparatus of claim 6, wherein the host device is configured to reset at least one of the second switch circuit and the processor when detecting a fault in the connection to the host device bus.

8. The apparatus of claim 6, wherein the receiver circuit includes a first transceiver circuit, and wherein the host device is configured to reset the first device via the transceiver circuit.

9. The apparatus of claim 6, wherein the transmission circuit of the first device includes a second transceiver circuit, and wherein the host device is configured to transmit information to the first device via the first and second transceiver circuits.

10. The apparatus of claim 9, wherein the first device includes a code hopping encoder circuit configured to encrypt a transmittable code, and wherein the host device is configured to transmit a key usable by the code hopping encoder circuit to encrypt the transmittable code.

11. The apparatus of claim 1, wherein a least a portion of the first device is included in a presence sensing mat.

12. The apparatus of claim 11, wherein the second device is an end device that includes an industrial safety and control system.

13. The apparatus of claim 11, wherein the second device is an end device, and wherein the end device includes at least one of:
a security system;
a face recognition system;
a kiosk;
an automated teller machine;
a remote control system;
an upgradeable access device; and
an actuating device.

14. The apparatus of claim 11, wherein the second device is an end device included in a kiosk, and wherein the kiosk includes face recognition technology.

15. The apparatus of claim 1,
wherein the first device includes a first plurality of switch circuits, and
wherein the transmission circuit is configured to transmit a wireless communication signal that includes information concerning the states of the plurality of switches, and
wherein the second device includes a second plurality of switches, and wherein, upon receipt of the wireless communication signal, the states of the second plurality of switches are synchronized to the states of the first plurality of switches.

16. A method comprising:
detecting an output of a sensing circuit using a first device, wherein first device includes a first switch circuit having a plurality of possible switch states;
transmitting a wireless communication signal upon the first switch changing state; and
receiving the wireless communication signal from the first device using a second device, wherein upon receipt of the wireless communication signal, a state of a second switch in the second device is synchronized to the state of the first switch in the first device.

17. The method of claim 16, including:
converting a transition of the first switch into a transmittable code that includes information about the state of the first switch, and
wherein transmitting a wireless communication signal includes transmitting the transmittable code in the wireless communication signal.

18. The method of claim 17, including encrypting the transmittable code, and wherein transmitting a wireless communication signal includes transmitting an encrypted wireless communication signal.

19. The method of claim 16, including initiating a sleep mode in the first device between transitions of the first switch circuit from a first state of the plurality of states to a second state of the plurality of states.

20. The method of claim 16, including initiating a reset of at least one of the first device or the second device using a host device, separate from the first and second devices, when the host device detects a fault in operation of the first and second devices.
